(19) United States
(12) Patent Application Publication
(10) Pub. No.: US 2009/0240496 A1
(43) Pub. Date: Sep. 24, 2009

(54) SPEECH RECOGNIZER AND SPEECH RECOGNIZING METHOD

(75) Inventors: Daisuke Yamamoto, Kawasaki-shi (JP); Hiroshi Sugiyama, Kawasaki-shi (JP); Toshiyuki Koga, Kawasaki-shi (JP); Kaoru Suzuki, Yokohama-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/404,505

(22) Filed: Mar. 16, 2009

(30) Foreign Application Priority Data
Mar. 24, 2008 (JP) 2008-076275

(51) Int. Cl. G10L 15/20; G10L 15/00

(52) U.S. Cl. 704/233; 704/246; 704/275; 704/251; 704/E15.039; 704/E15.006

(57) ABSTRACT

According to one aspect of the invention, a speech recognizer includes: an audio data acquiring portion configured to acquire audio data via a microphone; a speech section detecting portion configured to detect a talking start time and a talking end time based on the audio data; a spoken word identifying portion configured to identify the audio in a speech section from the talking start time to the talking end time; and a noise suppressing portion configured to suppress a generation of a noise from an electrical noise source for the speech section.

### CROSS-REFERENCE TO RELATED APPLICATIONS

This application is based upon and claims the benefit of priority from Japanese Patent Application No. 2008-076275, filed Mar. 24, 2008, the entire contents of which are incorporated herein by reference.

### BACKGROUND

1. Field

The present invention relates to a voice recognizing method and apparatus for operating an apparatus by using speech recognition.

2. Description of the Related Art

In recent years, with a diversification and computerization of electric household appliances, a large number of electric household appliances, for example, an AV apparatus including a television, a video, a DVD player and a hard disk recorder, housing facilities including an air conditioner, lighting device, and a fan have remote control system using infrared rays, and a large number of remote controllers are present in home. Moreover, the apparatuses are connected to a network so that an operation can also be carried out via the network. The number of apparatuses which can be thus operated remotely is increased and the respective apparatuses themselves also have many functions with a development of information technology (IT). Consequently, the number of operation buttons is increased and an operating procedure becomes complicated. A user has a plurality of remote controllers corresponding to the apparatuses and is to understand the meaning of the respective operation buttons for use.

To eliminate the difficulties of the complicated operation, an interface using a speech recognition that is easy to understand the correspondence between a meaning of an operation and a manipulation has attracted attention over the years. However, there is a disadvantage in that speech recognition has many recognition errors due to noise and has a low recognition rate.

The speech recognition generally includes a speech section detection processing for detecting a speech section (a talking section) of an audio and a spoken word identification processing for recognizing, as a vocabulary, a spoken word in the speech section. For the speech section detection processing, a method of executing a processing based on a threshold of an audio power is generally employed. It is preferable that the audio power in the speech section should be larger than a surrounding noise. The speech section detection processing is comparatively resistant to a noise. On the other hand, since the spoken word identification processing tries to match the spoken word with a lot of recognition vocabulary, it is comparatively weak against the noise. In some cases, the noise is recognized as the recognition vocabulary. This false recognition causes false operation without a voice instruction.

In order to prevent the false operation, there have been known a method as Push-to-Talk in which a push button switch is provided and is pushed to talk, a method of detecting a movement of lips (JP-A-4-184495), and a method of detecting a section corresponding to a distance from a user and changing an acoustic model set (JP-A-2003-131683). These also produce an advantage that a false recognition in non-talking is avoided, and furthermore, precision in the speech section detection is enhanced.

On the other hand, there has been known a method of terminating a speech recognition processing during a generation of a noise in order to prevent a noise generated from an apparatus side from being falsely recognized as a voice instruction (JP-A-4-24696 and JP-A-2002-116794). JP-A-4-24696 has described that the processing is terminated during an operation of a vehicle and JP-A-2002-116794 has described that the processing is terminated during the generation of a noise of a robot.

In the speech recognition, the spoken word identification is weaker against a noise than the speech section detection. In some cases, the speech section can be detected and the spoken word identification cannot be carried out due to many noises. Moreover, when the speech section can be detected is known to the user by turning ON an LED in the speech section detection, and a change in a volume or an elimination of the noise is carried out again to succeed in the speech section detection, thereby trying the talking again. On the other hand, whether the spoken word identification can be carried out is not known before the operation and the user cannot take measures. Accordingly, it is necessary to increase a spoken word identification rate. For this purpose, it is necessary to clearly acquire a voice in the spoken word identification.

In the Push-to-Talk, it is necessary for the user to operate the button in the vicinity of a speech recognizing apparatus or to hold an operation button such as a remote controller. A method of detecting lips in the speech section detection is hard to perform except for a head set. The method of terminating the speech recognition processing during the generation of a noise cannot be employed because a cooling fan or a device causing a noise are always operated and the speech recognition processing itself cannot be carried out.

### SUMMARY OF THE INVENTION

According to an aspect of the present invention, there is provided a speech recognizer including: an audio data acquiring portion configured to acquire audio data via a microphone; a speech section detecting portion configured to detect a talking start time and a talking end time based on the audio data; a spoken word identifying portion configured to identify the audio in a speech section from the talking start time to the talking end time; and a noise suppressing portion configured to suppress a generation of a noise from an electrical noise source for the speech section.

According to another aspect of the present invention, there is provided a voice recognizing method including: acquiring audio data; detecting a talking start time based on the audio data; starting suppressing a generation of a noise from an electrical noise source when the talking start time is detected; identifying the audio data while the noise suppressing; detecting a talking end time based on the audio data; and terminating the identification when the talking end time is detected.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing a structure according to a first embodiment of a speech recognizer,

FIG. 2 is a flowchart showing a processing operation according to the first embodiment of the speech recognizer,

FIG. 3 is a graph showing an example of a change in an audio power around a speech section,

FIGS. 4A to 4C are graphs showing examples of the change in the audio power around the speech section, FIG. 4A showing the case in which peripheral apparatuses including a fan are being operated, FIG. 4B showing the case in which the fan is stopped, and FIG. 4C showing the case in which the peripheral apparatuses including the fan are stopped,

FIG. 5 is a perspective view showing a concept according to a second embodiment of the speech recognizer,

FIG. 6 is a block diagram showing a structure according to the second embodiment of the speech recognizer,

FIGS. 7A and 7B are graphs showing examples of change in an audio power around a speech section, FIG. 7A showing the case in which an infrared light distance measuring sensor is being operated and FIG. 7B showing the case in which the infrared light distance measuring sensor is stopped, and

FIG. 8 is a block diagram showing a third embodiment of the speech recognizer.

### DETAILED DESCRIPTION

An embodiment according to the invention will be described below with reference to the drawings. Identical or similar portions to each other have common designations and repetitive description will be omitted.

### First Embodiment

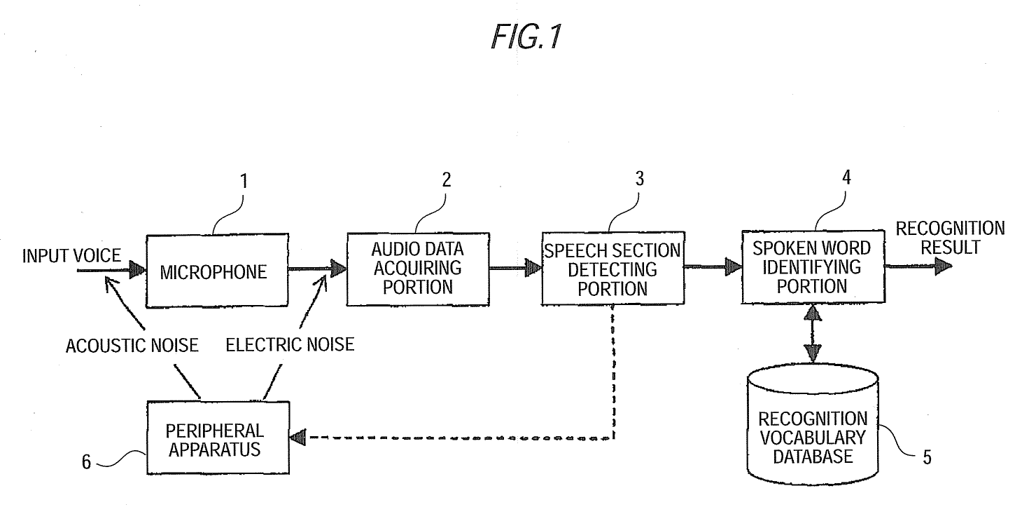

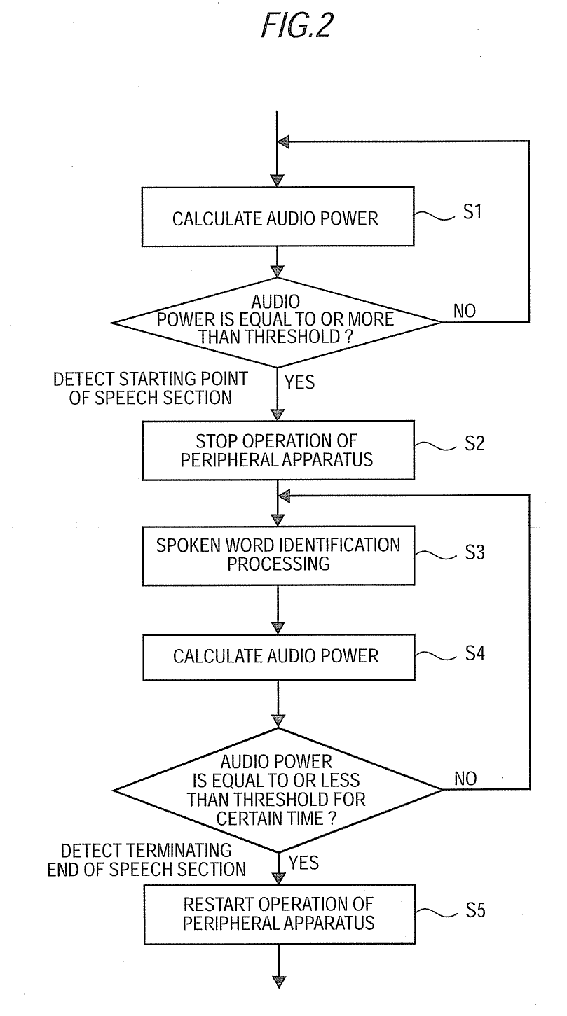

FIG. 1 is a block diagram showing a first embodiment of a speech recognizer according to the invention and FIG. 2 is a flowchart showing a processing operation according to the first embodiment.

The speech recognizer according to the first embodiment serves to operate various apparatuses (not shown), for example, an AV apparatus such as a television, a lighting device and an air conditioner by a voice of a user, and has a microphone 1, a audio data acquiring portion 2, a speech section (a talking section) detecting portion 3, a spoken word identifying portion 4, and a recognition vocabulary database 5 as shown in FIG. 1.

A voice input from the user is quantized at a certain gain and a certain sampling rate by the audio data acquiring portion 2.

The speech section detecting portion 3 serves to calculate an audio power of an audio data which is quantized and to detect the speech section that has a power higher than a certain threshold.

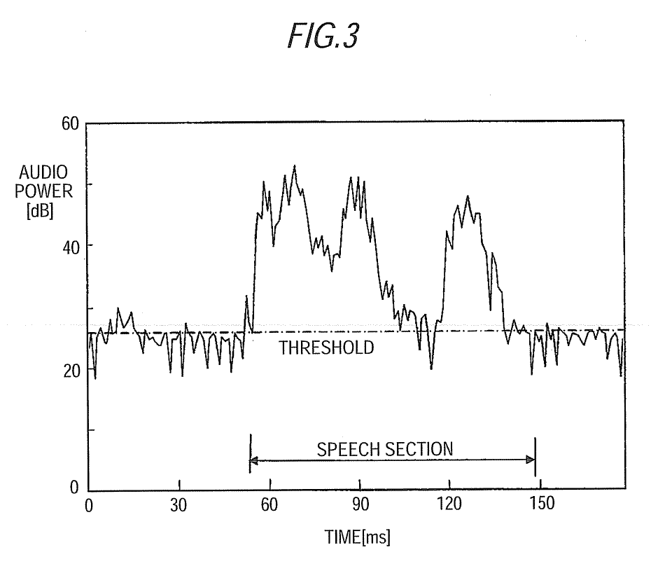

FIG. 3 is a graph showing an example of a change in the audio power around the speech section. As shown in FIG. 3, a duration in which the audio power of the voice waveform continuously exceeds the threshold is specified as the speech section.

In the case that the input voice exceeds the audio power threshold for a long period of time, there is a possibility that a noise which is equal to or more than the audio power threshold level might be made. Therefore, a processing for increasing an audio power threshold is executed.

The spoken word identifying portion 4 processes an audio data detected as the speech section and carries out a collation with the recognition vocabulary database 5, and outputs a recognition result. A manipulation to an operating target is executed based on the recognition result.

In the embodiment, there is terminated an operation of an apparatus which is not hindered due to a temporary stoppage in peripheral apparatuses (a cooling fan and a motor) 6 which might be acoustic and electrical noise sources to an input voice during the speech section detection of the speech section detecting portion 3. The speech section corresponds to a period that a user talks and is rarely detected all the time.

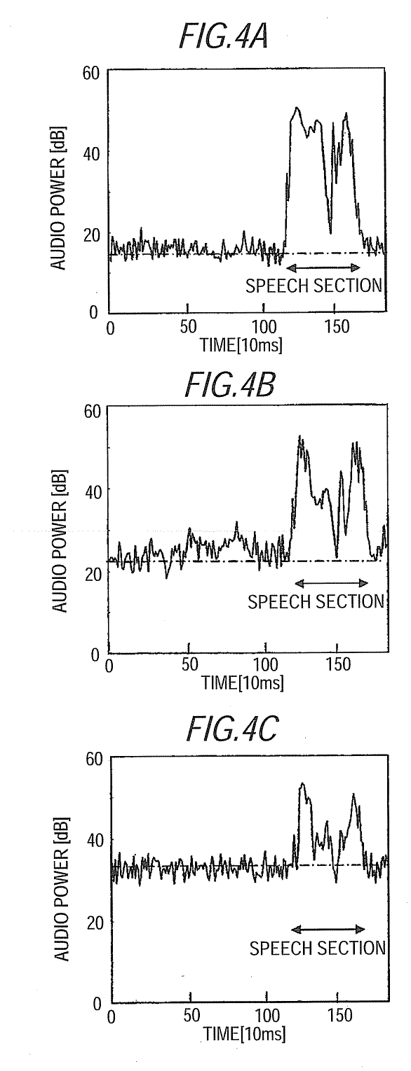

FIGS. 4A to 4C are graphs showing examples of a change in an audio power around the speech section in the speech recognizer, and FIG. 4A shows the case in which peripheral apparatuses including a fan are being operated, FIG. 4B shows the case in which only the fan is stopped and FIG. 4C shows the case in which the peripheral apparatuses including the fan are stopped. As shown in FIGS. 4A to 4C, the operations of the peripheral apparatuses which might be the acoustic and electrical noise sources to the input voice are stopped temporarily. Consequently, it is possible to suppress a noise in a processing of an audio data in the speech section in the spoken word identifying portion 4. Thus, it is possible to enhance precision in a spoken word identification.

In FIG. 2, a voice input from the microphone 1 is quantized by the audio data acquiring portion 2 and the audio power calculation processing of the speech section detecting portion 3 is carried out (Step S1). If the audio power is equal to or more than a threshold, a starting point of the speech section is detected. In the detection of the starting point, an operation of the peripheral apparatus to be a target is terminated (Step S2). Next, the spoken word identification processing is executed (Step S3). Moreover, the audio power at this time is calculated (Step S4). When the audio power is equal to or less than the audio power, subsequently, the operation of the peripheral apparatus is restarted (Step S5). In the example shown in FIG. 2, the spoken word identification processing (Step S3) is executed at any time after the detection of the starting point of the voice. As another example, it is also possible to employ a method to be executed when detecting a terminating end of the speech section.

According to the embodiment, it is possible to enhance a voice recognizing performance for operating target apparatuses with a peripheral apparatus having a large acoustic and electrical noise, for example, a CPU cooling fan.

### Second Embodiment

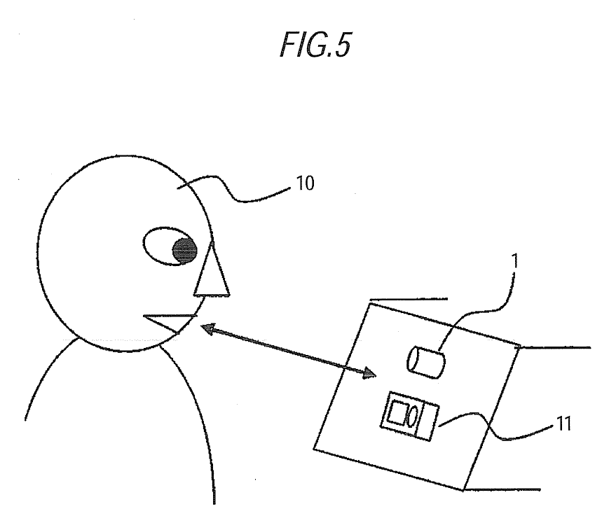

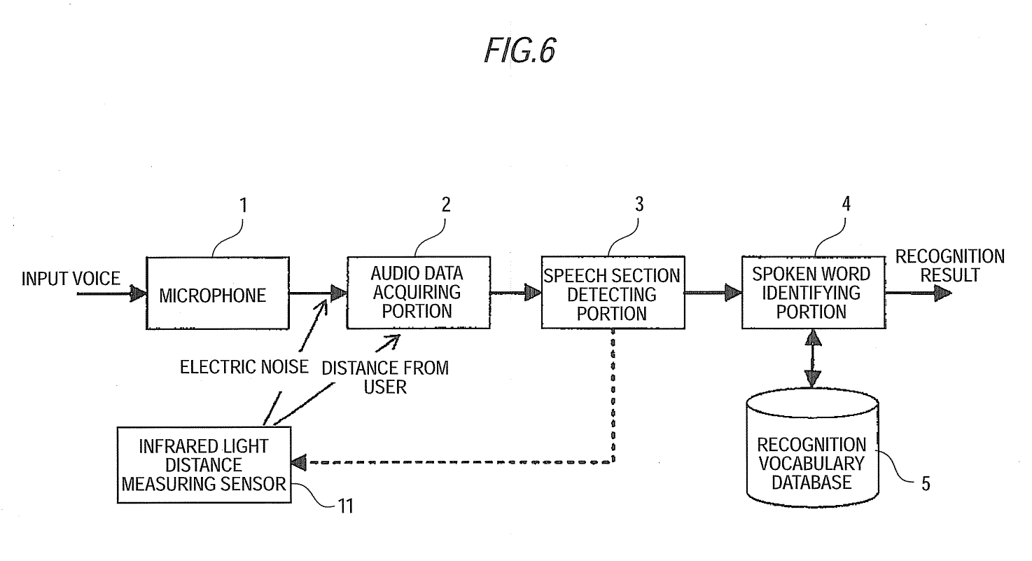

FIG. 5 is a perspective view showing a concept of a second embodiment of the speech recognizer and FIG. 6 is a block diagram showing the second embodiment of the speech recognizer.

In the embodiment, an infrared light distance measuring sensor 11 is disposed around a microphone 1 in order to measure a distance between a user 10 and the microphone 1 as shown in FIG. 5.

If it is decided that the user 10 is not close to the microphone 1 based on a result of a detection of the infrared light distance measuring sensor 11, a voice input to the microphone 1 can be decided to be a surrounding noise. Therefore, it is also possible to terminate a speech recognition processing, thereby preventing a malfunction from being caused by the surrounding noise. When the user 10 is detected, the speech recognition processing is carried out. A voice input in that case is regarded as a talking voice of the user 10 and a microphone gain can be controlled so as not to saturate the voice but to have a resolution which enables a spoken word identification.

In order to present a proper talking distance, furthermore, it is possible to display, as a proper distance corresponding to the surrounding noise when the user comes, a small distance because the microphone gain is small when the surrounding noise is large and a great distance because the microphone gain is great when the surrounding noise is small. Consequently, the user 10 can properly regulate the distance from the microphone 1 while seeing the display. To the contrary, it is also possible to control the microphone gain corresponding to the distance from the user 10 when the surrounding noise is small. More specifically, the gain is increased when the distance is great and is reduced when the distance is small.

The infrared light distance measuring sensor 11 serves to detect a distance by using an infrared-emitting diode and a PIN type photodiode (PSD (Position Sensitive Detector) position detecting device), for example. For a distance detecting method, there is employed an optical distance measuring method (a method of calculating a distance on a triangulation principle based on a position in which a reflected light is incident on a sensor). The method features that it is influenced by a color or reflectance of a detecting target with difficulty. The infrared light distance measuring sensor can calculate a distance inexpensively. Since an infrared light is emitted in a pulse, however, a large electrical noise is made.

In the embodiment, therefore, the infrared light distance measuring sensor 11 is set as the peripheral apparatus 6 to be a noise generating source according to the first embodiment and serves to terminate the operation of the infrared light distance measuring sensor 11 during a detection of a speech section. Consequently, it is possible to suppress a noise when processing an audio data within the speech section in the spoken word identifying portion 4, thereby enhancing precision in the spoken word identification.

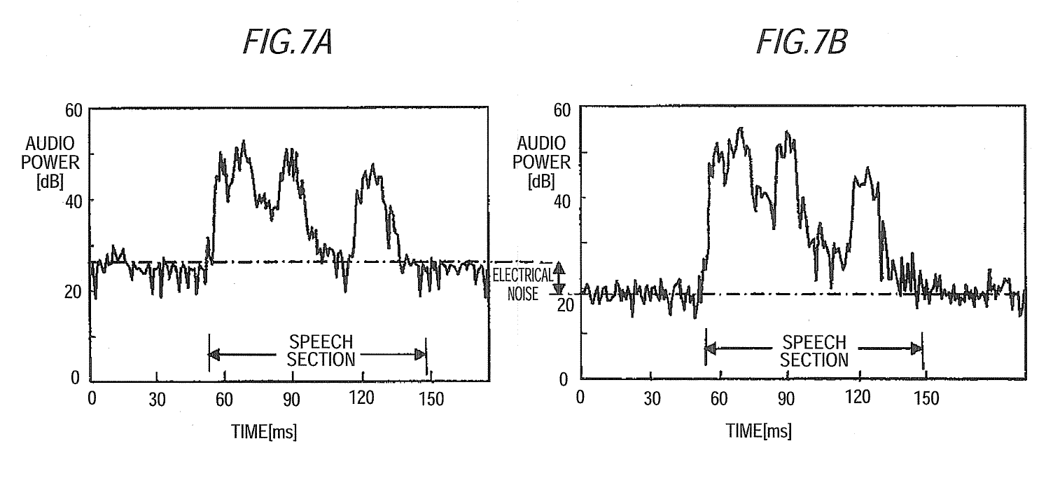

FIGS. 7A and 7B are graphs showing examples of a change in an audio power around the speech section in the speech recognizer, and FIG. 7A shows the case in which the infrared light distance measuring sensor is being operated and FIG. 7B shows the case in which the infrared light distance measuring sensor is not operated. As is apparent from FIGS. 7A and 7B, it is possible to reduce an electrical noise and to increase a speech recognition rate by terminating the operation of the infrared light distance measuring sensor even if a power supply is not separated or a special electric noise processing is not carried out.

### Third Embodiment

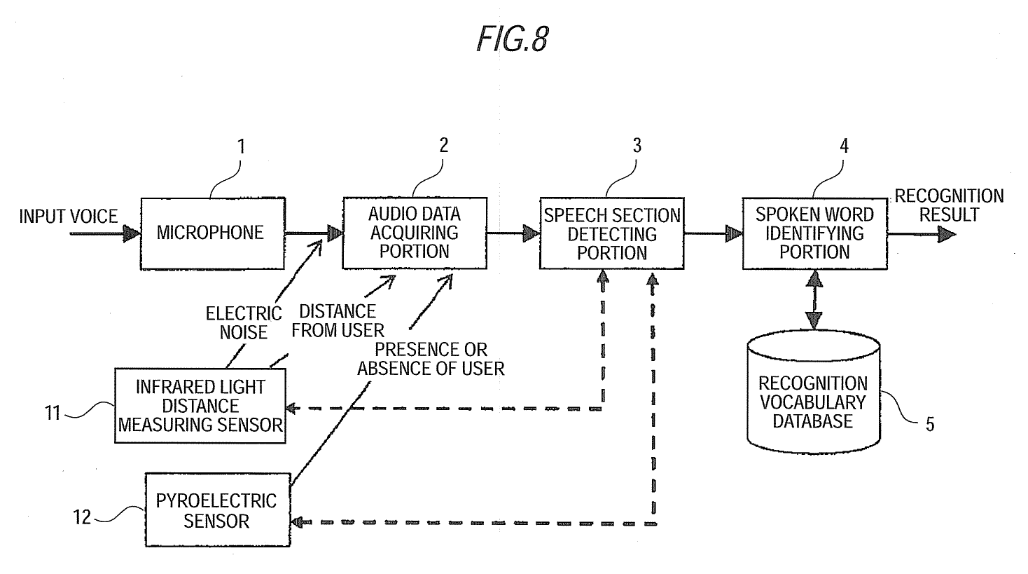

FIG. 8 is a block diagram showing a third embodiment of a speech recognizer according to the invention. The third embodiment is a variant of the second embodiment (FIG. 6), and a pyroelectric sensor 12 is also provided in addition to the infrared light distance measuring sensor 11 around a microphone 1. The pyroelectric sensor 12 detects a change in infrared rays generated from a heat generating object such as a human body (the user), thereby detecting a movement of the heat generating object.

In the case in which a fixed object other than a user 10 is present, there is a possibility that the detection might be failed based on only distance information obtained by the infrared light distance measuring sensor 11. Moreover, the infrared light distance measuring sensor 11 has a small measuring range. In the case in which a position of the user 10 is not placed on a normal of the infrared light distance measuring sensor 11, therefore, there is a defect that the user 10 cannot be detected. The pyroelectric sensor 12 catches a thermal change and detects a movement of a person through a change in a body temperature. Therefore, an object other than the person is detected with difficulty. Moreover, a detecting range is wide. On the other hand, the pyroelectric sensor 12 cannot carry out the detection if the person does not move. By detecting the user together with a distance detected by the infrared light distance measuring sensor 11 in the detection, therefore, it is possible to carry out a linkage to a voice recognizing noise reduction processing with high precision.

As described with reference to the embodiment, there is provided a speech recognizer and a voice recognizing method which decrease a recognition error due to a noise when operating an apparatus by using a speech recognition.

According to the embodiment, it is possible to decrease a recognition error due to a noise in the case in which an apparatus is operated by using a speech recognition.

What is claimed is:

1. A speech recognizer comprising:
an audio data acquiring portion configured to acquire audio data via a microphone;
a speech section detecting portion configured to detect a talking start time and a talking end time based on the audio data;
a spoken word identifying portion configured to identify the audio in a speech section from the talking start time to the talking end time; and
a noise suppressing portion configured to suppress a generation of a noise from an electrical noise source for the speech section.

2. The speech recognizer according to claim 1, further comprising a distance measuring sensor configured to measure a distance from the microphone to a talking user,
wherein the noise suppressing portion is configured to terminate an operation of the distance measuring sensor during the speech section.

3. The speech recognizer according to claim 2, wherein the distance measuring sensor configured to use an infrared light to measure the distance.

4. The speech recognizer according to claim 2 further comprising a gain control portion configured to control a gain of the microphone corresponding to the distance.

5. The speech recognizer according to claim 2, further comprising a spoken word identification control portion configured to terminate an operation of the spoken word identifying portion, when the distance is longer than a given distance.

6. The speech recognizer according to claim 1 further comprising a pyroelectric sensor configured to detect a movement of the user by measuring a change in infrared rays generated from the user; and
wherein a spoken word identification control portion configured to terminate an operation of the spoken word identifying portion, when the user is not determined to be separated from the pyroelectric sensor at a given distance or less.

7. The speech recognizer according to claim 1, wherein the electrical noise source including a PSD.

8. A voice recognizing method comprising:
acquiring audio data;
detecting a talking start time based on the audio data;
starting suppressing a generation of a noise from an electrical noise source when the talking start time is detected;
identifying the audio data while the noise suppressing;
detecting a talking end time based on the audio data; and
terminating the identification when the talking end time is detected.
